(19) United States
(12) Patent Application Publication
(10) Pub. No.: US 2004/0013410 A1
(43) Pub. Date: Jan. 22, 2004

(54) Recording/reproducing apparatus with two systems

(76) Inventors: Eiichirou Takinami, Takefu-City (JP); Hiroyuki Miyazaki, Takefu-City (JP)

Correspondence Address: Stanley P Fisher, REED SMITH LLP, 3110 Fairview Park Drive, Suite 1400, Falls Church, VA, 22042, US

(21) Appl. No.: 10/426,835

(22) Filed: May 1, 2003

(30) Foreign Application Priority Data
May 2, 2002 (JP) 2002-130783

(51) Int. Cl. H04N 5/76; G11B 15/04; G11B 19/04

(52) U.S. Cl. 386/94; 360/60; 380/201

(57) ABSTRACT

The object of the present invention is to provide a recording/reproducing apparatus with two systems of recording/reproducing units which can record video pictures and reproduce the video pictures, thereby resulting in a compact constitution and making it possible to reduce the manufacturing costs.

The recording/reproducing apparatus with two systems is constituted of a first recording/reproducing unit 1 for recording and reproducing video pictures, a first copy protection detection circuit 6 for the first recording/reproducing unit 1, a second recording/reproducing unit 2 for recording and reproducing video pictures, a second copy protection signal detection circuit 7 for the first recording/reproducing unit 2, a control circuit 5 for controlling the operations of the first recording/reproducing unit 1 and the second recording/reproducing unit 2, and a single-provided video signal processing circuit 3 for processing a video signal inputted from the first recording/reproducing unit 1 or the second recording/reproducing unit 2.

### BACKGROUND OF THE INVENTION

1. Field of the Invention

The present invention relates to a recording/reproducing apparatus with two systems of recording/reproducing means.

2. Prior Art

A recording/reproducing apparatus can record video pictures on a recording medium and reproduce the video pictures on a TV monitor to monitor those video pictures. And, some recording/reproducing apparatuses have two systems of unit for recording and reproducing video pictures.

In these recording/reproducing apparatuses comprising the two systems, there are such recording/reproducing apparatuses which are constituted to do so-called dubbing recording that video pictures are reproduced by one system and the reproduced video pictures are recorded by other system.

And, in the above-described recording/reproducing apparatus comprising the two systems, two sets of video signal processing circuit or the like are provided, those of which are required to be equipped to reproduce video pictures by one set and record the video pictures by the other set. Therefore, such a recording/reproducing apparatus comprising the two systems is constituted of pluralities of components, thus formed into a large sized apparatus, and also increased in its manufacturing costs.

### SUMMARY OF THE INVENTION

It is, therefore, an object of the present invention to provide a recording/reproducing apparatus with two systems, which can be miniaturized by reducing components, thereby reducing manufacturing costs.

In order to solve the above problems, the recording/reproducing apparatus with two systems according to the present invention is provided with:

a first recording/reproducing means for recording video pictures on a first recording medium and reproducing the video pictures recorded on the first recording medium;

a first copy protection signal detection circuit for detecting copy protection signals contained in a video signal pertaining to video pictures reproduced by the first recording/reproducing means;

a second recording/reproducing means for recording video pictures on a second recording medium and reproducing the video pictures recorded on the second recording medium;

a second copy protection signal detection circuit for detecting copy protection signals contained in a video signal pertaining to video pictures reproduced by the second recording/reproducing means;

a single-provided video signal processing circuit for processing a video signal pertaining to video pictures reproduced by either one of the first recording/reproducing means and the second recording/reproducing means in order to record the reproduced video pictures on the other one of the first recording/reproducing means and the second recording/reproducing means; and

a control means for controlling the recording that the video pictures reproduced by one of the first recording/reproducing means and the second recording/reproducing means are recorded by the other one of the first recording/reproducing means and the second recording/reproducing means, based on copy protection signals detected by the copy protection signal detection circuit for one of the first recording/reproducing means and the second recording/reproducing means.

The recording/reproducing apparatus with two systems in the present invention is constituted such that one of the first recording/reproducing means and the second recording/reproducing means operates to reproduce and a video signal outputted from said one of the first recording/reproducing means and the second recording/reproducing means is processed by the single-provided video signal processing circuit.

Thus, because of the single-provided video signal processing circuit, the apparatus according to the present invention can be formed into a small sized one in its entire dimension and the manufacturing costs of the apparatus can be reduced.

### BRIEF DESCRIPTION OF THE DRAWINGS

For a better understanding of the invention, reference is made to the accompanying drawing, in which:

FIG. 1 is a block diagram showing one embodiment of a recording/reproducing apparatus with two systems according to the present invention.

### DETAILED DESCRIPTION OF THE PREFERRED

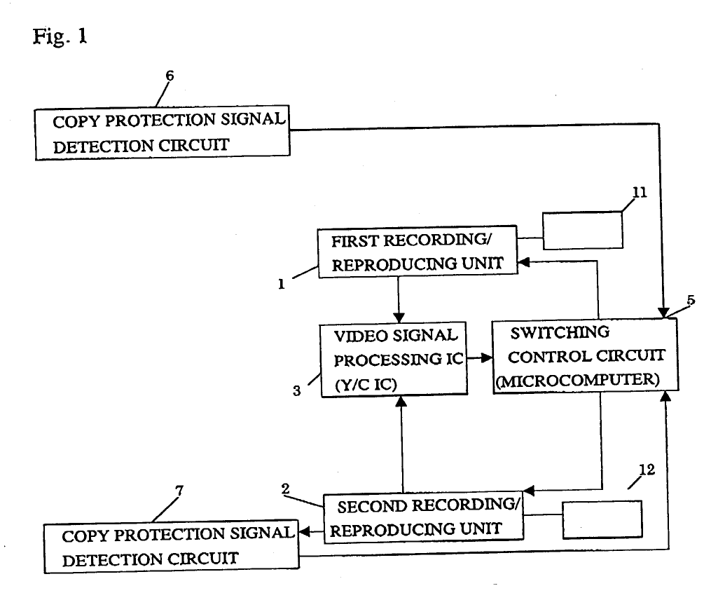

The recording/reproducing apparatus with two systems of recording/reproducing means according to the present invention is shown in FIG. 1, wherein a schematic view of the recording/reproducing apparatus with two systems is shown. The present recording/reproducing apparatus with two systems is provided with a first recording/reproducing unit 1, a first copy protection signal detection circuit 6 for the first recording/reproducing unit 1, a second recording/reproducing unit 2, a second copy protection signal detection circuit 7 for the second recording/reproducing unit 2, a video signal processing circuit 3, and a switching control circuit 5.

The first recording/reproducing unit 1 is provided with a first recording medium. When the first recording/reproducing unit 1 is set to be in a recording mode and inputted a video signal, the video data based on the video signal are recorded on the first recording medium.

When the first recording/reproducing unit 1 is set to be in a reproducing mode, video data recorded on the first recording medium are read out, and the first recording/reproducing unit 1 outputs a video signal corresponding to said video data. The first recording/reproducing unit 1 corresponds to the first recording/reproducing means.

A first TV monitor 11 can display video pictures processed by the first recording/reproducing unit 1, thereby making it possible to monitor the video pictures.

Namely, when a video signal outputted from the first recording/reproducing unit 1 is inputted to the first TV monitor 11, the first TV monitor 11 displays the video pictures on the basis of the inputted video signal. And, it is also possible to arrange the first TV monitor 11 such that, when the first recording/reproducing unit is set to be in a recording mode and receives a video signal, the same video signal is inputted to the first TV monitor 11 for displaying the video pictures recorded by the first recording/reproducing unit 1.

When a video signal outputted from the first recording/reproducing unit 1 is inputted, the first copy protection signal detection circuit 6 detects copy protection signals contained in the video signal. And, after detecting the copy protection signals, the first copy protection signal detection circuit 6 outputs a first detection signal to the switching circuit 5.

The second recording/reproducing unit 2 is provided with a second recording medium. When the second recording/reproducing unit 2 is set to be in a recording mode and a video signal is inputted, the video data based on the video signal are recorded on the second recording medium.

When the second recording/reproducing unit 2 is set to be in a reproducing mode, video data recorded on the second recording medium are read out, the second recording/reproducing unit 2 outputs a video signal corresponding to the video data. The second recording/reproducing unit 2 corresponds to the second recording/reproducing means.

A second TV monitor 12 can display video pictures processed by the second recording/reproducing unit 2, thereby making it possible to monitor the video pictures.

Namely, when a video signal outputted from the second recording/reproducing unit 2 is inputted to the second TV monitor 12, the second TV monitor 12 displays the video pictures on the basis of the inputted video signal. And, it is also possible to arrange the second TV monitor 12 such that, when the second recording/reproducing unit is set to be in a recording mode and receives a video signal, the same video signal is inputted to the second TV monitor 12 for displaying the video pictures recorded by the second recording/reproducing unit 2.

When a video signal outputted from the second recording/reproducing unit 2 is inputted, the second copy protection signal detection circuit 7 detects copy protection signals contained in the video signal. And, after detecting copy protection signals, the second copy protection signal detection circuit 7 outputs a second detection signal to the switching circuit 5.

The video signal processing circuit 3 processes a video signal inputted thereto and outputs the processed signal to the switching control circuit 5. And the video signal processing circuit 3 also outputs a discrimination signal which represents the presence of a video signal or the like according to the requirement for processing in the switching control circuit 5.

The video signal processing circuit 3 is constituted mainly of a video signal processing IC (Y/C IC). Either the first recording/reproducing unit 1 or the second recording/reproducing unit 2 is set to be in a reproducing mode, and a video signal outputted from the first recording/reproducing unit 1 or the second recording/reproducing unit 2, whichever is set to be in a reproducing mode, is inputted to the video signal processing circuit 3.

The switching control circuit 5, which corresponds to a control means, controls the operation of the recording/reproducing apparatus with two systems. The switching control circuit 5 is provided with a storage section and an operation section, not shown in FIG. 1, which may be constituted of a microcomputer.

The switching control circuit 5 controls the operations of the first recording/reproducing unit 1 and the second recording/reproducing unit 2. And each of the first recording/reproducing unit 1 and the second recording/reproducing unit 2 is controlled to operate in a recording mode for recording video pictures or to operate in a reproducing mode for reproducing recorded video pictures by the switching control circuit 5.

Further, the switching control circuit 5 outputs a video signal inputted from the video signal processing circuit 3 to the first recording/reproducing unit 1 or the second recording/reproducing unit 2, whichever is set to be in a recording mode.

In addition, the first detection signal outputted from the first copy protection signal detection circuit 6 and the second detection signal outputted from the second copy protection signal detection circuit 7 are inputted to the switching control circuit 5.

When the first or second detection signal is inputted, the switching control circuit 5 processes the inputted video signal so as not to record video pictures by the first recording/reproducing unit 1 or the second recording/reproducing unit 2, whichever is set to be in a recording mode, or controls the first recording/reproducing unit 1 or the second recording/reproducing unit 2, whichever is set to be in a recording mode, so as not to record video pictures.

Further, the contents controlled by the switching control circuit 5 are set by a remote controller, not shown. Namely, the contents controlled by the switching control circuit 5 can be set by the operation of the user of the apparatus.

And, the user can select, by operating the remote controller, whether to operate the first recording/reproducing unit 1 and the second recording/reproducing unit 2 in a recording mode or in a reproducing mode.

Hereunder, explanations will be made regarding the operation examples of the recording/reproducing apparatus with two systems according to the present invention.

### (1) First Example of Operations

As a first example of operations, the case where the first recording/reproducing unit 1 is operated in a reproducing mode and the second recording/reproducing unit 2 is operated in a recording mode will be explained hereunder.

First, the user operates the remote controller and implements a selecting operation so that the first recording/reproducing unit 1 is operated in a reproducing mode and the second recording/reproducing unit 2 is operated in a recording mode.

In the recording/reproducing unit 1, the video data recorded on the first recording medium are reproduced, and the first video signal corresponding to the video data is outputted from the first recording/reproducing unit 1 The first video signal outputted from the first recording/reproducing unit 1 is outputted to the TV monitor 11, the first copy protection signal detection circuit 6 and the video signal processing circuit 3, respectively.

The TV monitor 11 displays video pictures reproduced by the first recording/reproducing unit 1. In the first copy protection signal detection circuit 6, a detection whether the inputted first video signal contains a copy protection signal is conducted. And, in the case where the first video signal contains a copy protection signal, the first copy protection signal detection circuit 6 outputs the first detection signal to the switching control circuit 5.

The first video signal is inputted to the video signal processing circuit 3 and, after being processed in the video signal processing circuit 3, inputted to the switching control circuit 5.

In the case where the first detection signal is inputted from the first copy protection signal detection circuit 6, the switching control circuit 5 does not output the inputted first video signal to the second recording/reproducing unit 2. Thus, in the second recording/reproducing unit 2, video pictures based on the first video signal are not recorded on the second recording medium.

On the other hand, when the first copy protection detection circuit 6 does not detect a copy protection signal contained in the first video signal and the first detection signal is not inputted to the switching control circuit 5, the first video signal is outputted from the switching control circuit 5 to the second recording/reproducing unit 2, and video pictures based on the first video signal are recorded on the second recording medium.

### (2) Second Example of Operations

As a second example of operations, the case where the first recording/reproducing unit 1 is operated in a recording mode and the second recording/reproducing unit 2 is operated in a reproducing mode will be explained hereunder.

First, the user operates the remote controller and implements a selecting operation so that the first recording/reproducing unit 1 is operated in a recording mode and the second recording/reproducing unit 2 is operated in a reproducing mode.

In the recording/reproducing unit 2, the video data recorded on the second recording medium are reproduced, and the second video signal corresponding to the video data is outputted from the second recording/reproducing unit 2. The second video signal outputted from the second recording/reproducing unit 2 is outputted to the TV monitor 12, the second copy protection signal detection circuit 7 and the video signal processing circuit 3, respectively.

The TV monitor 12 displays video pictures reproduced by the second recording/reproducing unit 2. In the second copy protection signal detection circuit 7, a detection whether the inputted second video signal contains a copy protection signal is conducted. And, in the case where the second video signal contains a copy protection signal, the second copy protection signal detection circuit 7 outputs the second detection signal to the switching control circuit 5.

The second video signal is inputted to the video signal processing circuit 3 and, after being processed in the video signal processing circuit 3, inputted to the switching control circuit 5.

In the case where the second detection signal is inputted from the second copy protection signal detection circuit 7, the switching control circuit 5 does not output the inputted second video signal to the first recording/reproducing unit 1. Thus, in the first recording/reproducing unit 1, video pictures based on the second video signal are not recorded on the first recording medium.

On the other hand, when the second copy protection detection circuit 7 does not detect a copy protection signal contained in the second video signal and the second detection signal is not inputted to the switching control circuit 5, the second video signal is outputted from the switching control circuit 5 to the first recording/reproducing unit 1, and video pictures based on the second video signal are recorded on the first recording medium.

The recording/reproducing apparatus with two systems as explained heretofore is provided with two recording/reproducing units, and is capable of recording video pictures reproduced by one of the two recording/reproducing units on the other recording/reproducing unit, thereby making the constitution thereof compact. In other words, as provided with the single processing circuit 3, the recording/reproducing apparatus with two systems according to the present invention is compactly constituted, thereby making it possible to downsize the apparatus in its entire dimension. Further, reducing of manufacturing costs can be attained.

On the other hand, in a recording/reproducing apparatus provided with conventional two recording/reproducing units, which is constituted such that video pictures reproduced by one unit are recorded on the other unit, each recording/reproducing unit has been provided with a video signal processing circuit. Consequently, two video signal processing circuits have been provided for one recording/reproducing apparatus. Therefore, it was required to have a space for two video signal processing circuits, thus leading to a large sized apparatus.

According to the present invention, as explained heretofore, the recording/reproducing apparatus with two systems is provided with the single video signal processing circuit 3, so that downsizing the apparatus can be attained and manufacturing costs can be reduced.

What is claimed is:

1. A recording/reproducing apparatus with two systems provided with:
a first recording/reproducing means for recording video pictures on a first recording medium and reproducing said video pictures recorded on said first recording medium;
a first copy protection signal detection circuit for detecting copy protection signals contained in a video signal pertaining to video pictures reproduced by said first recording/reproducing means;
a second recording/reproducing means for recording video pictures on a second recording medium and reproducing said video pictures recorded on said second recording medium;
a second copy protection signal detection circuit for detecting copy protection signals contained in a video signal pertaining to video pictures reproduced by said second recording/reproducing means;
a single-provided video signal processing circuit for processing a video signal pertaining to video pictures reproduced by either one of said first recording/reproducing means and said second recording/reproducing means in order to record said reproduced video pictures on the other one of the first recording/reproducing means and the second recording means; and
a control means for controlling the recording that video pictures reproduced by one of said first recording/reproducing means and said second recording/reproducing means are recorded by the other one of said first recording/reproducing means and said second recording/reproducing means, based on copy protection signals detected by said copy protection signal detection circuit for one of said first recording/reproducing means and said second recording/reproducing means.
